(19) United States
(12) Patent Application Publication
(10) Pub. No.: US 2015/0052043 A1
(43) Pub. Date: Feb. 19, 2015

(54) Method and System for Allocating Charitable Contribution Based Upon Credit and Debit Card Discount Fees

(71) Applicant: Kevin Michael Todd, Raleigh, NC (US)

(72) Inventor: Kevin Michael Todd, Raleigh, NC (US)

(21) Appl. No.: 13/965,366

(22) Filed: Aug. 13, 2013

(51) Int. Cl. G06Q 30/02; G06Q 20/34; G06Q 20/22

(52) U.S. Cl. CPC G06Q 30/0279; G06Q 20/22; G06Q 20/34
USPC 705/39

(57) ABSTRACT

The computerized method/system allocates charitable contributions based upon credit/debit card discount fees selected by a vendor. An intermediary payment processor (IPP) permits the vendor to select fees/rates and charity. The IPP either (a) calculates an estimated charitable contribution based upon vendor's sales or (b) permits the vendor to select the charity's allocated rate. When the credit/debit card is processed, an allocated portion of the discount fees from each card transaction is delivered to the IPP's bank (which may be an escrow in the card processor's bank). The IPP bank pays this allocation periodically to the charity and the bank reports payments to the IPP, which in turn reports, via the web-portal, to the vendor. The vendor can make prospective changes. The system includes a rate selector, an input module, a charitable contribution calculator, a vendor's report display module, a transaction payment monitor, and a payment module for the charitable fee.

The present invention relates to a method and a system for allocating charitable contributions based upon credit card discount fees and/or debit card discount fees which are customarily paid by the vendor of goods or services who accepts credit cards and debit cards. The term “discount fees” is a common term in the credit card and debit card processing industry to represent a reduction in the fees paid to a vendor. The discount is the difference between the consumer's charge/debit slip and the amount paid the vendor of the goods or services. For example, if a vendor's customer charges (or debits) $100.00 worth of goods or services, the vendor may be paid about $95.00, representing a 5% discount fee or 5% discount rate.

There are numerous credit card processing companies that act as intermediaries between the vendor and the card issuer bank (the bank that issues the debit card or credit card to the consumer). Hence, the vendor has a choice of credit/debit card processor companies. Since the consumer is not directly impacted by the discount fees, and since the vendor's business owner may wish to make periodic charitable contributions based upon total sales by the vendor to consumers, there is a need for a system and a method to divert a portion of the discount fees to the vendor's designated charity.

### OBJECTS OF THE INVENTION

It is an object of the present invention to provide a method and a system for allocating charitable contributions to a vendor selected charity based upon credit and debit discount fees typically deducted from the credit and debit charge slips processed by the card issuing bank.

It is a further object of the present invention to provide the vendor with a selection of either discount fees or charities thereby permitting the vendor to select the discount fee, the allocation for charitable contribution, and the charity.

It is another object of the present invention to provide an electronic transactional system whereby the charitable contributions are accumulated in an intermediary processing bank and subsequently released to the charity on a periodic basis such as quarterly or yearly. Upon the release of these charitable allocated funds, reports are generated to the vendor documenting the charitable contribution.

### BRIEF DESCRIPTION OF THE DRAWINGS

Further objects and advantages of the present invention can be found in the detailed description of the preferred embodiments when taken in conjunction with the accompanying drawings in which:

FIGS. 1 and 2 diagrammatically illustrate prior art systems and methods;

FIG. 3A diagrammatically illustrates a process-system diagram in accordance with the principles of the present invention;

FIG. 3B diagrammatically illustrates a custom web page or landing page for the charitable contribution program;

FIG. 4A diagrammatically illustrates a process and system diagram showing the flow of funds, discount fees and charitable allocation fees in accordance with principles of the present invention;

FIG. 4B diagrammatically illustrates that the credit card processor may have a charitable contribution module or system (the charitable contribution module sometimes referred to as herein as the intermediary payment processor);

FIG. 4C diagrammatically illustrates some key modules or sub-systems in the intermediary payment processor (IPP);

FIG. 5 diagrammatically illustrates a flowchart enabling the vendor to select either a discount fee, a discount rate or a charity, all subject to the charitable contribution process, in accordance with the principles of the present invention; and

FIG. 6 is a continuation of FIG. 5 which shows a reporting function.

### SUMMARY OF THE INVENTION

The computerized method allocates charitable contributions based upon credit or debit card discount fees, which are selected by a vendor of goods or services from a plurality of card discount fees. The method and system is enabled over a telecommunications network operable between said vendor's credit or debit card device, an associated card processor's computer system, a corresponding card issuer bank system, a vendor's bank system, an intermediary payment processor, an intermediary payment processor bank system, and a charity's bank system. The intermediary payment processor (IPP) has a web-based server portal and a reporting module. The vendor, via the web portal, selects a discount fee or a rate from said plurality of discount fees. Of course, the vendor also select the charity. The selected discount fee corresponds to the associated card processor, and, in turn, the card processor has a relationship with the card-issuing bank. The method and system may be configured to either (a) calculate an estimated charitable contribution to the charity based upon the vendor's input of a monthly sales (otherwise quarterly or weekly or yearly sales) or (b) the IPP server, at the web portal, may display a discount rate percentage to be allocated to said charity as a result of vendor's sales. The vendor selects the card processing rate or the fee, and the charity.

The system and method then operates by establishing not only the typical electronic transactional relationship between the vendor's credit or debit card device, the associated card processor's computer system, the corresponding card issuer bank system, and the vendor's bank system, but also incorporates the IPP's bank system and the charity's bank system. When a credit or debit card transaction is initiated at the vendor's credit or debit card device (by a consumer purchase), the charge/debit slip is processed by the associated card processor's computer system, the card issuer bank system, the vendor's bank system, and the IPP's bank system to the effect that an allocated portion of said discount fees from each credit or debit card transaction is delivered to the IPP's bank. Effectively, a portion of the discount fee is paid to the card issuing bank, a portion is paid to the card processor and a portion is paid to the IPP and an allocation from these portions is paid to the charity. The IPP bank reports payments based upon the allocated portion of the discount fees to the IPP module or subsystem. This allocated portion of the discount fees is delivered, by the computer method, to the charity's bank from the IPP's bank on a predetermined periodic basis (monthly, quarterly, yearly or otherwise). Ultimately, the charity reports the amount received to the vendor. At the IPP's web portal, the vendor can view the charitable donations accumulated, but not yet distributed, as needed. Also, the vendor can prospectively change the allocated portion to the charity. In one embodiment, the card processor incorporates the IPP (therefore, the IPP bank is the card processor bank, but this bank has a special account, like an escrow account, for the allocated charity funds).

The system includes means for selecting, at the server portal, the discount fee or rate and the charity. The IPP includes an input module for accepting an estimate of vendor sales, a calculator for estimating a charitable contribution based upon the selected discount and the estimated vendor sales. The web portal has a display module which shows the vendor (who has input the informational data) either (a) an estimating charitable contribution or (b) the discount rate percentage to be allocated to the charity as a result of vendor's sales. In the latter case, the allocation discount rate is less than the selected discount (the selected discount referring to the card processor required rate or percentage). The system also includes a transaction payment monitor (part of the IPP module or sub-system) coupled to either (a) the associated card processor's computer system or (b) the card issuer bank system. The transaction monitor is also coupled to the IPP bank. The transaction payment monitor tracks a portion of said discount fees from each credit or debit card transaction which portion is deposited into the IPP bank based upon credit card or debit card discount fee payments originating from said vendor's credit or debit card device. The system also includes a payment module which effects payment of at least an allocated amount of funds from the discount fee portion. The payment module compiles allocations over a predetermined time period and thereafter instructs the payment of compiled allocated funds to the charity's bank from the IPP bank. Additionally, the transaction payment monitor tracks the electronic transfer of all compiled allocated funds from the IPP bank to the charity's bank. The IPP has a further display module which displays all transferred compiled allocated funds for the period of time to the vendor at the web portal as a report on the charitable contributions to the charity.

### DETAILED DESCRIPTION OF THE PREFERRED EMBODIMENTS

The present invention relates to a method and a system for allocating charitable contributions based upon credit card and debit card discount fees. The Abbreviations Table near the end of this patent specification provides some additional information about abbreviations used in the specification and used in the drawings. Similar numbers designate similar items throughout this patent specification.

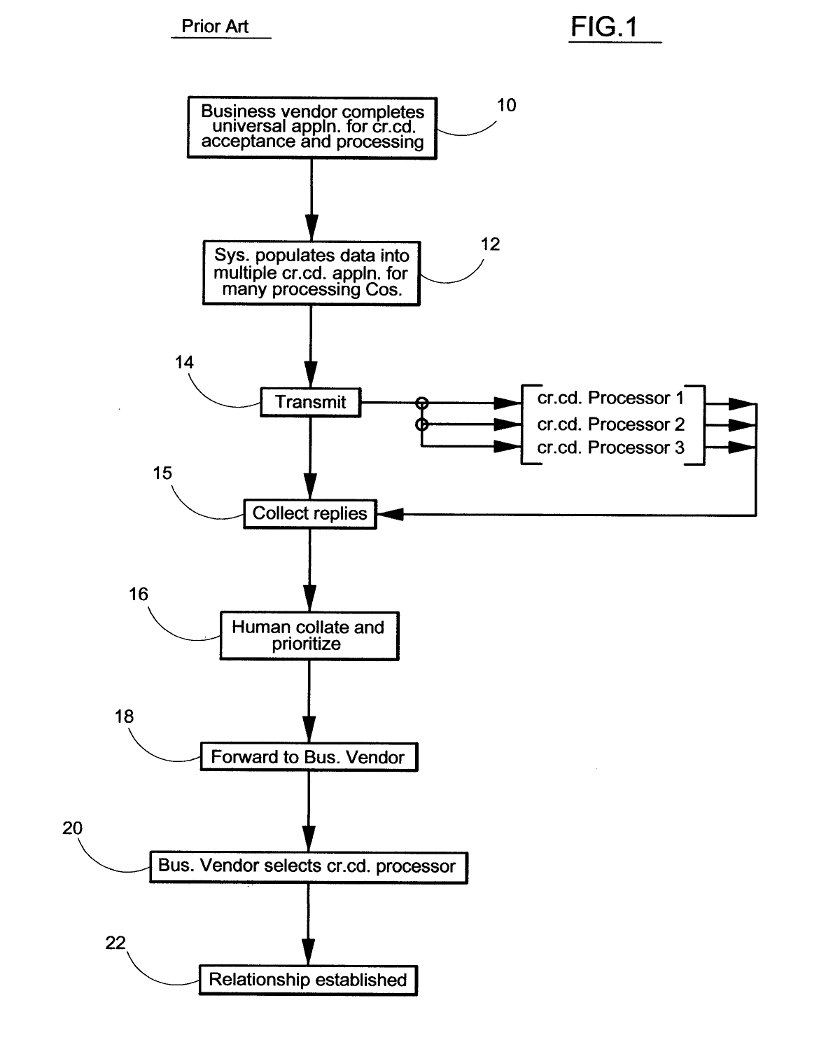

FIGS. 1 and 2 diagrammatically illustrate prior art systems. With respect to FIG. 1, in functional block 10, a business vendor completes a universal application for credit card acceptance and processing. In other words; a business vendor must make an application to accept credit cards issued by card issuing banks. Sometimes in this patent specification, the term “credit card” refers equally to both credit as well as debit card, however the operation of the system and the computer-based method is essentially the same with regard to whether a credit transaction is processed or whether a debit card transaction is processed. Both credit and debit cards are subject to discount fees or rates. In function block 12, the system, typically a card processor computer system, populates data from the universal application (completed by the vendor in step block 10) and creates multiple credit cards applications for many different card processing companies. The vendor may be required to approve and sign each unique application. In step 14, the unique credit card processing application for the business vendor (step 10) is transmitted to a number of credit card processors identified as processors 1, 2, 3 in FIG. 1.

These processors provide replies and these replies are collected and collated in step 15 by the credit card processor computer system. In step 16, a person at the credit card processor company correlates and prioritizes these replies from the credit card processors 1, 2, 3. Step 16 notes that some or all of the credit card processor replies are forwarded to the business vendor. In step 20, the business vendor, typically in cooperation with the credit card processing company, selects a particular credit card processor. In step 22, a financial transactional relationship is established between the vendor, the vendor's bank, the card processor and the card issuer bank. Further, step 22 recognizes that an electronic transactional relationship is established. This is further explained in the prior art diagram of FIG. 2.

In FIG. 2, the common processing of a credit card or debit card is illustrated. Vendor 24 delivers goods or services 26 to a customer and the customer initiates a charge or a debit event 28 resulting in a charge/debit slip 30 being received by the vendor. The vendor electronically transmits charge slip 31 into the electronic transactional over the telecommunications channel (may be the Internet or other secure telecomm channel). The electronic slip 31 is presented to credit card processor 26. Ultimately, the charge slip 31 is presented to credit/debit card issuer bank 34. Thereafter, card issuer bank 34 issues a bill 36 reporting the transaction to the customer. In a debit card situation, the customer's bank account is decremented or reduced. Instead of a bill 36 being sent to the customer, an electronic notice or report indicating the debit to the customer's account is sent to the customer.

The card issuer bank 34 also pays a certain discount fee $m to credit card processor 26. This discount fee may be considered a handling charge fee paid to the credit card processor. Further, the card issuer bank 34 also receives a portion of the discount fee $n which represents the bank's transactional charges. Pursuant to the financial relationship described in FIG. 1, in step 22, the card issuer bank 34 sends a certain amount of money to the vendor's bank 38 on behalf of vendor 24. This reduced payment, “$ less-disc” is, in the earlier example, $95 assuming a 5% discount rate and a $100 charge slip 30 initiated by a credit or debit event between vendor 24 and the customer. See credit or debit charge 28. Vendor bank 38 sends a notice of credit 40 for $ less-disc to vendor 24.

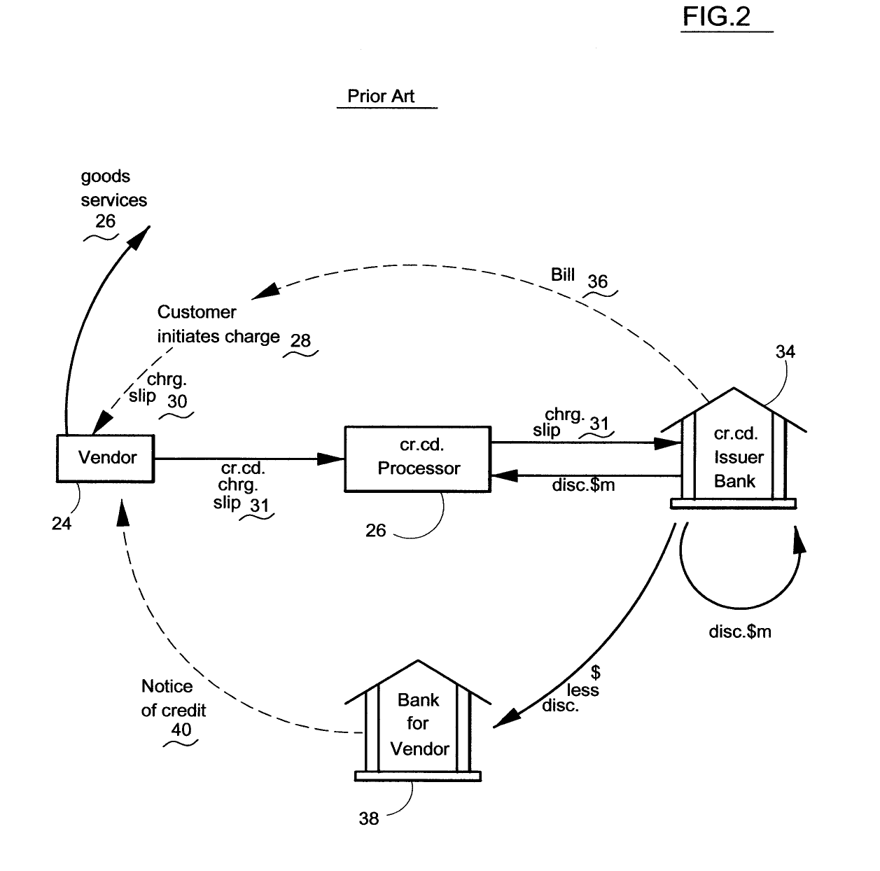

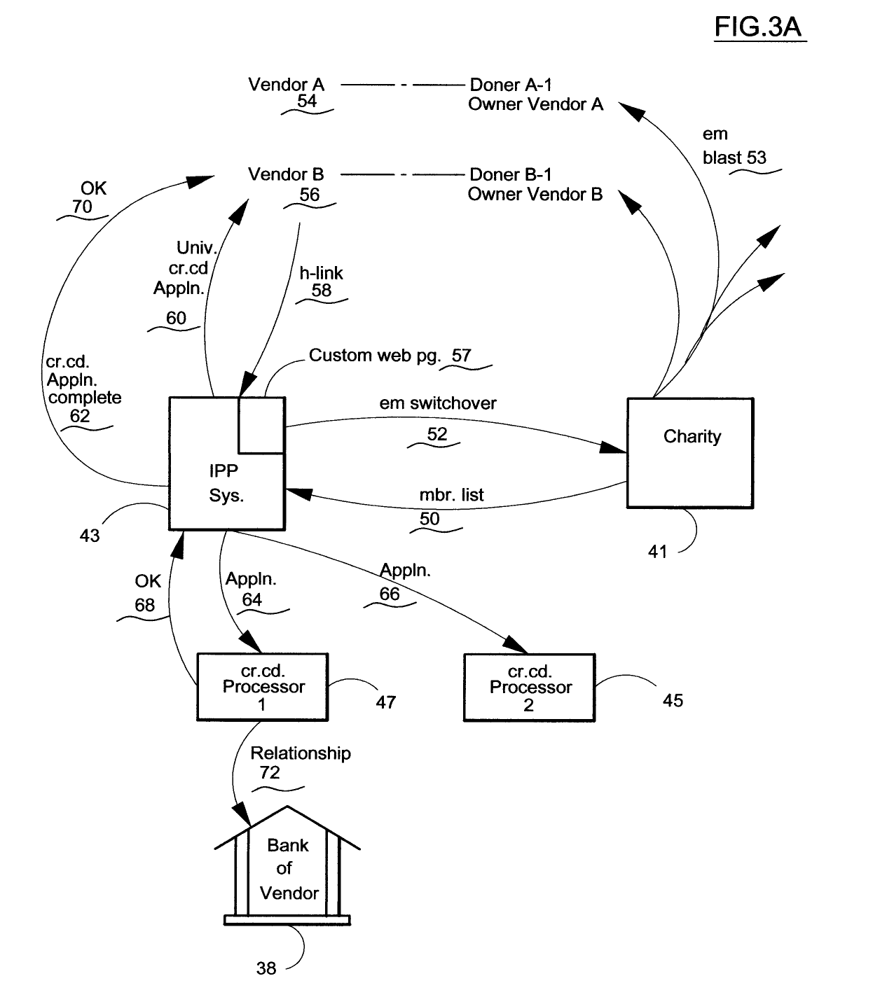

As indicated earlier, the present method diverts a portion or an allocation of the discount fee to a vendor designated charity. FIG. 3A is a process and a system diagram showing key elements of the inventive system and method. In a preferred embodiment, charity 41 electronically submits data representing a membership list 50 including email addresses and names of various vendor-business owners, generally described in FIG. 3A is Donor A-1 Vendor A associated with Vendor A 54 and Donor B-1 Vendor B for Vendor B 56. The membership list with the emails and the names of the vendors and names of owner-vendor A 54 and owner-vendor B 56 are supplied to the intermediary payment processor system 43 by charity 41. In a preferred embodiment, the data transfer is electronic. The intermediary payment processor (IPP) system 43 develops a custom web page 57. A basic format for an example of custom web page 57 is shown in FIG. 3B. The charity may develop or approve the custom web page prior to its use. Further, the emails in the email blast to vendors A 54 and B 56 may be sent by charity 41 after the form and format of the email is created by the IPP 43 and approved by charity 41.

In FIG. 3B, the exemplary custom web page 57 includes a segment describing the program 202, the name of the charity in a banner segment 204, a description of the charity itself in segment 206, and local ads or relational ads in display segment 208. This landing web page on the IPP web portal is produced and will be displayed to potential owners (owner-vendor A, owner-vendor B) as needed. Also, charity 41 could advertise in brochures, newsletters, in supplemental email blasts, on its own charity web site and in search engines the availability of this discount fee diversion charitable giving program. A link to custom lending web page 57 is provided in these supplemental communications and events.

When a user-visitor selects the hyperlink in these supplemental communications to IPP's custom web page 57, the user-visitor lands on the uniquely designed landing webpage at the web portal of the intermediary payment processor (IPP) system. The IPP web portal serves up and displays the information shown on custom landing page 57 to the user-visitor. Other formats for the landing page could be provided. Further, the landing page could be configured for a smart phone or mobile device or for Ipods or tablet display screens.

As is known in the client-server or web design industry, the custom landing page 57 may initially reside on the charity web-based server 41 in which case the user-visitor would trigger the web-portal of the charity server 41 when the user-visitor selects the hyperlink from the email or supplemental communication. However, the user-visitor's client computer (smart phone, mobile device, tablet or other Internet-enabled device) is then re-directed to the IPP system and processing module 43. The user-visitor may not notice this re-direction to the IPP. In any event, the majority of the diversion of the charitable allocation is processed by the IPP because the IPP has the financial relationship with the card processor and the card issuer bank and the vendor. It should be noted that the card processor may operate an IPP module as a distinct part of its operations.

Returning to FIG. 3A, the IPP system and processor 43 generates an email format and sends the email “switch-over” batch over 52 to charity 41. This “switch-over” refers to a change in the card processor by the vendor B 56 and the addition of a charitable diversion of funds from the base discount fee charged by the financial participants. In other words, most vendors have established card processor relationships which, in the preferred embodiment, must be switched over to the charitable donation card processor—IPP system.

In a preferred embodiment, charity 41 sends out in an email blast 53 the pre-formatted customized emails addressed to owner-vendor A 54, owner-vendor B 56 and to other individuals who may be associated with the charity or who have expressed an interest in funding charity 41. Since the email established by IPP processor 43 and approved by charity 41 has a hyperlink to custom web landing page 57, when the owner-vendor A or owner-vendor B reads the email and owner-vendor B 56 selects hyperlink 58, vendor B 56 arrives at custom landing web page 57.

The IPP processor 43 then generates a universal credit card processing application 60 which is sent to vendor B 56. In this operational process, vendor A 54 has not selected hyperlink 58. Vendor B 56 completes the universal credit card processing application as noted by communication 62 which application is sent to the IPP processor and system 43. The IPP processor then customizes the universal credit card and debit card processing application for vendor B and sends out a unique application 64 and 66 to credit processor 1 (block 47) and credit processor 2 (block 45). Note that reference to “credit card” in the Figures also refers to debit card processing.

In this illustrative embodiment, the IPP system 43 and credit processor 1 establishes the relationship 72 with vendor's bank 38 and the card issuer bank or banks (not shown). Concurrently, the IPP system 43 sends an approval (OK) communication 70 to vendor B signifying both the financial relationship and the electronic transactional relationship.

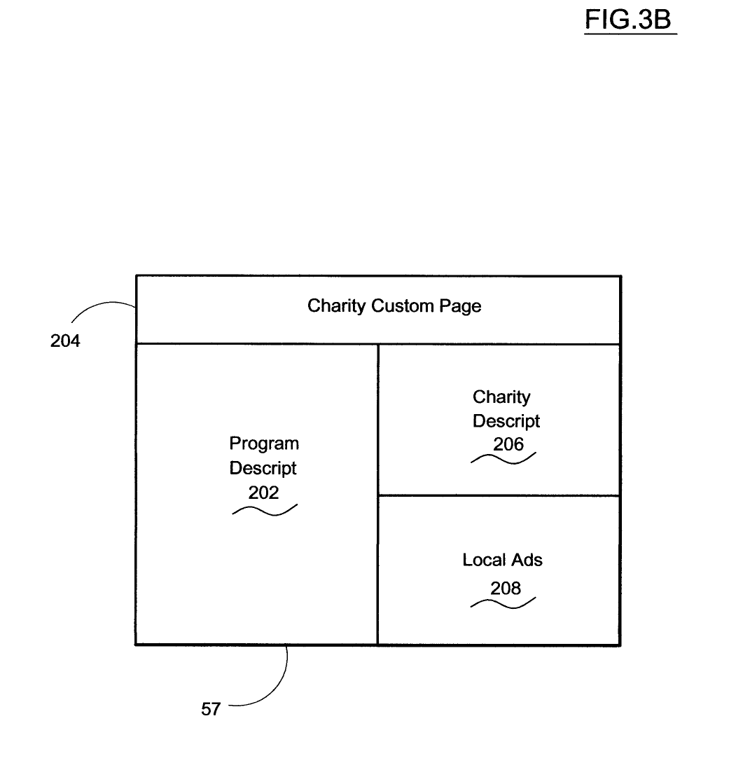

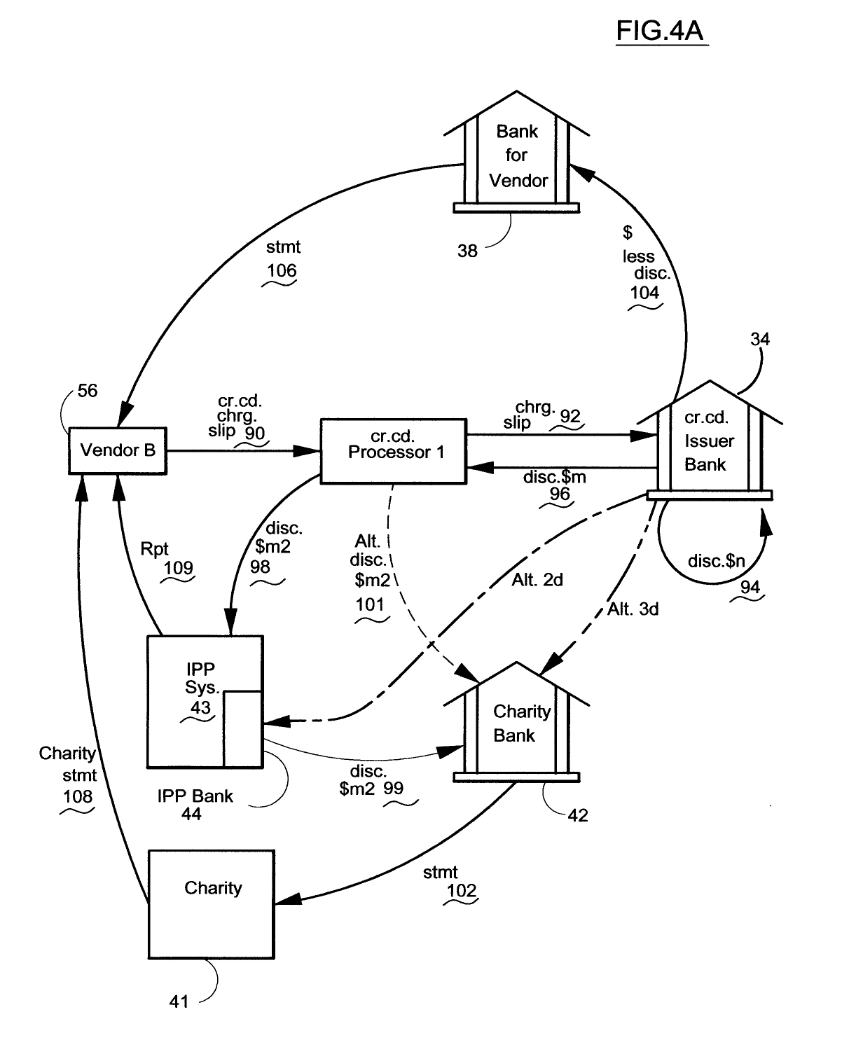

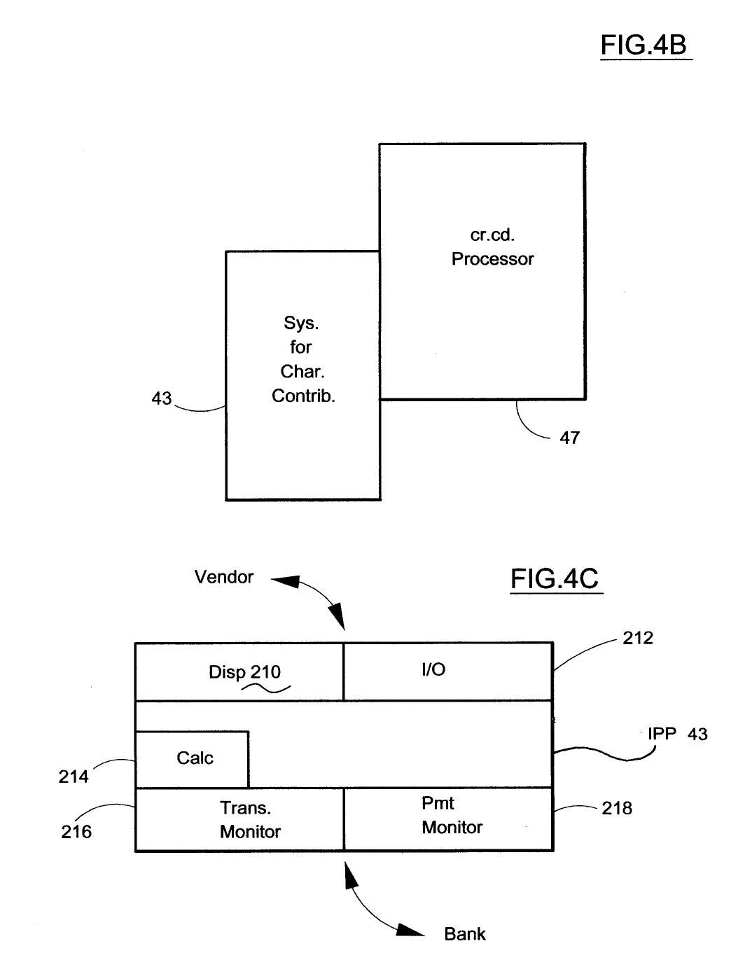

FIG. 4A shows a process and a system in accordance with the principles of the present invention. In FIG. 4A, credit processor 1 is independent of the intermediary payment processor (IPP) system 43. In different embodiments (see FIG. 4B), the credit card processor may have a module or option for credit card charitable contribution thereby integrating the IPP processing system into the credit card processor business, plan and system.

The process and the method begins in vendor B (block 56) that electronically generates a credit card or debit card charge slip 90 which is electronically submitted to credit card processor 1. That slip or electronic representation of the charge/debit slip, is then submitted to credit or debit card issuer bank 34. See slip 93. Bank 34 then pays, via an electronic transaction, a discount fee $m (item 96) to credit card processor 1 for handling the charge slip or debit slip. Further, issuer bank 34 deducts another discount transactional fee $n (item 94) for its processing fee. Fees $in and $n are portions of the discount fee paid by vendor 56. The bank 34, after all discount fees are deducted, submits in step 104 certain funds to vendor's bank 38. Vendor bank 38 then sends a statement 106 to vendor B 56.

However, since vendor B has selected charity 41 to receive a certain allocation from a portion of the discount fee effectively paid to credit card processor 1, this apportioned discount fee in step 98, represented as “disc $m1,” is paid to intermediary payment processor (IPP) 43. Alternatively, the credit issuer bank 34 could pay $m2 to IPP system 43 as noted by path alt. 2d and the dash-dot-dash lines in FIG. 4A. Amount $m1 may or may not equal amount $m2. As a further alternative, issuer bank 34 could pay the charitable allocation from a portion of the discount fees as shown by path alt 3d and the dash-dot-dot-dash lines in FIG. 4A. In other words, the banking arrangement could have the issuer bank 34 (a) pay credit processor 1 all discount fees $m and the credit processor 1 could then pay a portion of the discount fees $m1 to IPP processor who in turn would pay a smaller portion of the fees $m2 (step 99) to charity bank 42; (b) pay IPP 43 directly (or more properly IPP bank 44) and then the IPP 43 deposits discount fee $m2 into charity bank 42; or (c) issuer bank 34 could pay charity bank 42 directly and issue reports to credit card processor 1 and IPP system 43. The latter alt 3d path is less likely since it involves two or three payments by card issuer bank 34 which, most likely, increases discount fee $n and complicates the card payment system generally. Payment plan $m and then $m1 is more likely since it is less costly and the IPP-card processor financial relationship involves the charity bank 42 and therefore disassociates card issuer 34 from the charity obligations.

Whether the IPP 43 collects the money directly or collects the money in an escrow account in an IPP bank system, IPP bank 44 is where the money goes directly and then subsequently into charity bank 42. The IPP system 43 generates a report 109 to vendor B. The report is on the IPP web portal for display to the vendor 56. Additionally, charity 41 issues a charity statement 108 to vendor B.

Preferably, the since the allocated-charitable discount fees could be quite small, these disc $m2 (step 99), disc $m2 on alt 2d or fees on alt 3d are accumulated in IPP bank 44 or a card processor bank (not shown, but if so collected, may be in a card processor escrow account). The card processor escrow account may be a general escrow account, not a separate escrow of each charity. Periodically, for example quarterly, semi-annually or annually, the escrow in IPP bank 44 (or escrow in card processor bank) (not shown) releases those funds to charity bank 42. In this manner, vendor B monitors the (a) accumulated charity funds, not yet released and (b) the released charitable funds, by accessing the web portal at IPP 43. The amount of accumulated charitable contributions is shown on a secure, password protected vendor unique web-portal. However, a financial contract has been established by vendor B and the IPP processor 43 such that during a period of time, the charitable allocation from portions of the discount fees ($m) are designated to the charity 41. Although the vendor B may prospectively cancel or alter the discount rate or the discount fee allocation to a particular charity and further may change the vendor designated charity, during the earlier fixed predetermined period of time, the IPP system has dedicated that charitable contribution and escrow to the charity 41. In other words, once $m1 is receive by IPP bank 44, such allocated charitable contribution is fixed. The exception to this fixed payment is bankruptcy or other legal proceeding, and as explained later, charge backs to the credit/debit card.

FIG. 4B shows that the credit card processor may have an IPP module 43 that enables it to make charitable contributions based upon allocation from a portion of the discount fees $m. In other words, FIG. 4A shows an independent system between credit card processor and the IPP system 43. FIG. 4B recognizes that in some situations, the credit processor 47 may have a charitable donation component module 43 established with an IPP bank 44 (an escrow in the card processor bank) such that vendors using the card processor 47 would select a discount rate and select a charity to receive the benefit of an allocation of the discount fees that the vendor typically pays for debit card processing and credit card processing.

FIG. 4C diagrammatically shows that the IPP system has a web page portal including a display module, an input/output module 212, a display module 210 (causing a unique web page display to the vendor as a client-server configuration), a calculator 214, a transaction monitor 216, and a payment monitor 218. The payment monitor is electronically coupled to the associated IPP bank 44 (or processor escrow) and charity bank 42. In some situations, the payment monitor 218 is electronically coupled to the card issuer bank 34. The payment monitor monitors payments as they flow through the system and out to the charity bank. Transaction monitor 216 also monitors the transactions and generates reports as needed to the card processor 1 and internal reports to the IPP processor 43. The payment monitor makes the payments; the transaction monitor tracks account values $m1 and accumulated funds during the predetermined pay-out dates. Calculator 214 is used to inform vendor B of the amount of charitable contribution he or she would donate to charity bank 42 based upon one or more different charities or different discount rates. The calculator may also sum the interim accumulated finds $m1 for a single vendor-charity. Display unit 212 provides a web page portal and serves up pages to the vendor computer enabling vendor B to monitor the growth of his or her charitable contributions. Input/output module 212 operates over a telecommunications network such that the IPP system 43 electronically communicates with the various entities and computer systems described earlier.

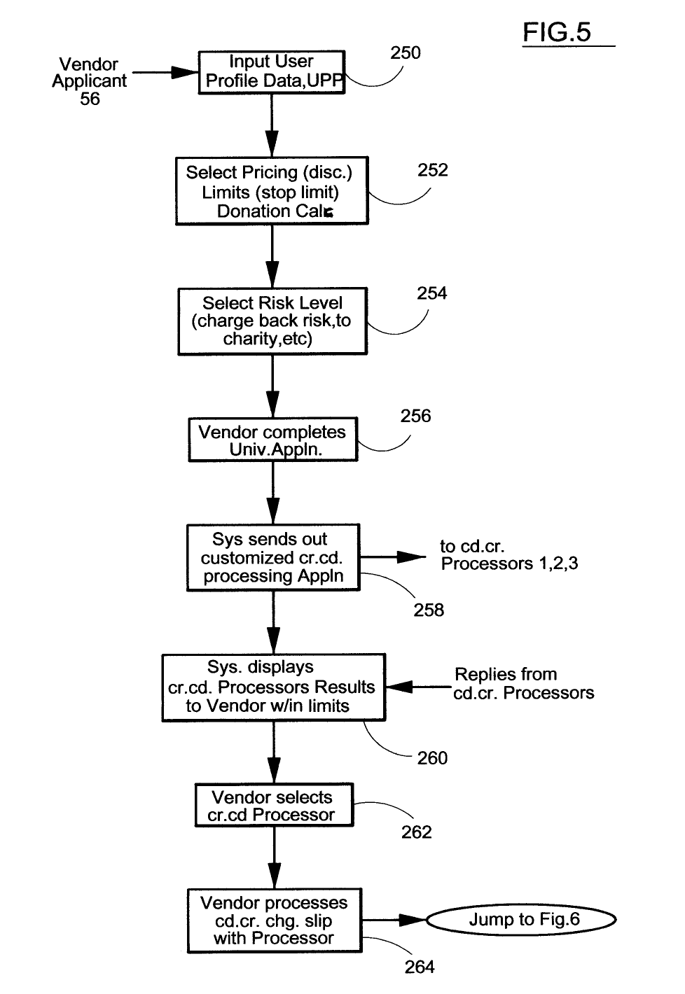

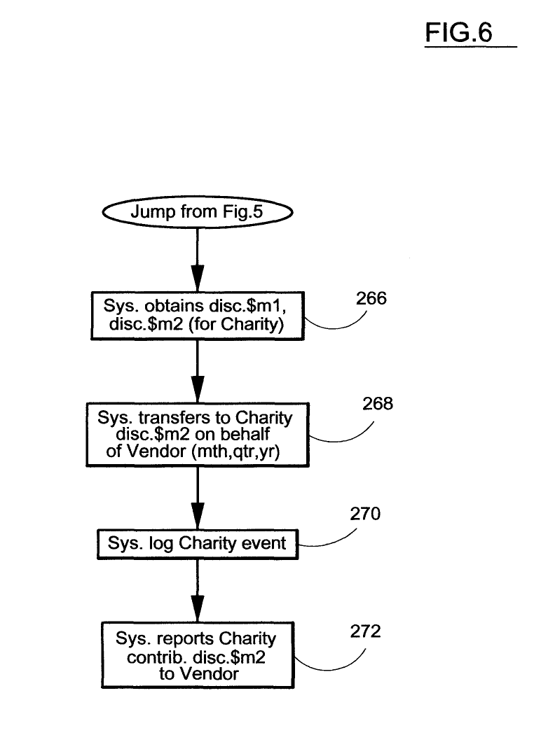

FIGS. 5 and 6 diagrammatically show a process or a flowchart for the present invention. In step 250, vendor applicant 56 inputs data such as the vendor 56 user personal profile or UPP. In some situations, the vendor company or business may want to show the charitable contribution. In other instances, the owner of the vendor 56 would want the charitable contribution to be shown individually. In step 252, the web portal on IPP system 43 displays to vendor applicant 56 a pricing structure or a discount fee or rate.

The following Contribution Table provides an example of the display. Certain columns may be omitted in the display and others may be added.

Contribution Table

| Disc Rate | Char. Rate | Est. Sales (per period) | Est. Char. Contrib. $ |
|---|---|---|---|
| 3.0 | 0.25 | Pull down | X1 |
| 3.25 | 0.28 | 10K | X2 |
| 3.35 | 0.30 | 20K | X3 |
| 3.5 | 0.32 | 30K | X4 |

There are two configurations available for the display presentation to vendor 56. In one presentation, the discount rate as a percentage is shown. In the Contribution Table listed above (which is completely exemplary and may not reflect actual transactional fees), discount rates ranging from 3.0 percent to 3.5 percent are shown. In one embodiment, the vendor 56 is shown the charitable contribution as a rate. In the exemplary Contribution Table, charity rates of 0.25 percent to 0.32 percent are listed for discounts 3.0 to 3.5. Other discount rates and other charitable contribution rates may be available. In other words, if the vendor in the first instance selects discount rate 3.0, the charity rate for each card transaction is 0.25%. From a $100 charge or debit customer event, the total discount rate would be $3.00 and from that $m transactional discount rate, the allocated charitable contribution is $0.25 ($m2). Please note that $m1 is less than $m2 due to a small transaction fee paid to IPP 43 for the handling charge, set-up and custom reporting functions. In another embodiment, the web based server portal of IPP system 43 permits the vendor to input or the vendor to select from a pull down menu, his or her gross monthly sales. Other accounting periods could be used other than monthly (such as weekly or daily). In any event as an example in the Contribution Table, the vendor has a pull down menu which permits vendor to select $1 OK per month or $20K per month or $30K per month as an estimate of gross card processing amounts (an estimate of all slips 90 per that accounting period). Vendor selects the estimated card charges for the predetermined period of time and vendor selects the discount rate (left column).

A calculator 214 in IPP system 43 then calculates the estimated charitable contribution for the predetermined period of time. In one instance that may be a charitable contribution on a monthly basis. However, the IPP processor 43 could show annual charitable contributions in order to provide a better appearance and support to the charity to the vendor. Small charitable allocations look “better” when accounted for over longer periods of time. In this manner, the IPP has a server portal which obtains either an estimate of the vendor sales and calculates an estimated charitable contribution to the charity based on the estimated sales. The IPP 43 effects a display on the server portal to the vendor. In this situation, the vendor is operating a client computer in a web based server-client system. The IPP is the server. Alternatively, the server portal in IPP system 43 effects a display showing the discount rate percentage to be allocated to the charity as a result of the vendor sales. Therefore, in step 252 (FIG. 5) the vendor selects the charity as well as the discount rate and the charitable allocation. Variations and combinations of this information may be provided to the vendor making the selection.

In step 254 of FIG. 5, the vendor selects a risk level for the particular discount rate. As it can be appreciated, every business has a certain level of charge backs or disputes with consumers or returns of product. These consumer disputes and returns of product translate into credit notes slips (not shown) being electronically transmitted through the debit card and credit card processing system. The “pay the vendor” process is described earlier in connection with FIGS. 1 and 2 and persons of ordinary skill in the art understand the charge-back process. The charge back or dispute risk level affects the discount rate available to the vendor and also affects the potential charitable contribution. Since there is a credit risk and a charge back risk, this affects the delivery of charitable funds to the charity bank 42. Once a charitable contribution is delivered to charity bank 42, it is difficult, if not impossible, to obtain a refund of that fee. However, it is possible that card processor 1 may be required to pay some money back from $m (step 96) and IPP system 43 may be required to return a certain amount of money from $m1, all paid back to issuer bank 34 in the event of a charge back for dispute. These charge backs and return risks are part of the contractual arrangement established between credit card processor 1 and the card issuer bank 34. In the event IPP processor 43 is independent of credit card processor 1, the same charge back risk can be shared between credit card processor 1 and IPP processor 43. For this reason, the IPP processor 43 has a small transaction fee (not shown) retained, thereby making $m2 less than $m1.

In step 256, the vendor 56 completes the universal credit card processing application. In step 258, the card processor sends out the customized processing application to several card processors 1, 2, 3. As stated earlier, the card processing application is also used for debit card processing application.

In step 260, replies are gathered from the card processors and the system displays the processor results to the vendor within certain limits. In other words, the limits may be established by the charity (no payments less than $x1) or may be preestablished by the vendor (no discount fees greater than $y1 or y1%). Further, the card processor may only present certain information to the vendor that fits within the card processor's own financial business plan. A high degree of charge back and risk may result in a higher discount fees to the credit processors and these processors may be dropped out due to insufficient monetary contribution to the processor business itself.

In step 262, the vendor selects a card processor. In step 264, the vendor processes a credit/debit card slip with the processor. This initiating step is step 90 between vendor B and card processor 1 in FIG. 4A. The system then jumps to FIG. 6.

In FIG. 6, which is a continuation of FIG. 5, the system obtains the discount $m1 fee form the card processor and allocates charitable amount discount $m2 to an escrow (less a small IPP processing fee). In step 268, the system transfers to the charity bank 42 the discount fee $m2 on behalf of vendor. Typically this happens at a periodic time such as monthly, quarterly or yearly. Other times may be selected by the vendor (or as set by the charity) if the accumulated $m2 amount to be transferred is reasonable. Transferring small amounts increases IPP's transactional costs. In step 270, the system logs the charitable event in the IPP 43 memory. In step 272, the system reports the charitable contribution $m2 as a total of all $m2 contributions to the charitable bank 42 over the predetermined period of time to vendor B.

Abbreviations Table

| | |
|---|---|
| ad | advertisement |
| Admin | Administrator |
| A-com | computer or memory store for common or remainder data |
| addr | address - typically an IP address |
| alt. | alternate or optional path or step |
| API | application program interface |
| appln. | application, typcially made by user of system |
| ASP | application service provider - server on a network |
| B-ext | computer or memory store for extracted data |
| bd | board |
| Bus. | Business |
| CD-RW | compact disk drive with read/write feature for CD disk |
| Char. | Charity |
| chrg | credit card charge slip |
| comm. | communications, typically telecommunications |
| contrib. | contribution, as in charitable contribution |
| Cos. | companies |
| CPU | central processing unit |
| cr. cd. | credit card |
| db | data base |
| descript | description |
| disc | discount, as in discounting a credit card charge slip |
| Disp | display, typically display a web page or display certian |
| | information |
| doc | document |
| dr | drive, e.g., computer hard drive |
| DS | data storage |
| e | encryption |
| em | email |
| Equip | equipment |
| est | estimate |
| ext-data | extracted data |
| Geo | geographic location or code (geo. loc. is GPS data) |
| GPS | geo positioning system and location (optionally time data) |
| HR | human resources or regional manager |
| h-link | hyper link to a web page |
| I/O | input/output |
| I-com | Internet storage for common or remainder data |
| id | identify |
| I-ext | Internet storage for extracted data |
| IPP | Intermediary Payment Processor System or Module |
| loc | location |
| loc. ptr. | displayed location on a displayed map |
| mem | memory |
| Mess | message as in SMS or text message |
| mbr. | member |
| MLS | multilevel security |
| obj | object, for example, a data object |
| opt | optional, as in an alternative path or step |
| pgm | program |
| Pro | provider, such as RX Pro, Medical Provider, namely, a doctor |
| P/W | password |
| Rcd | database record or record profile |
| re | regarding or relating to |
| recon | reconstruct |
| Reg'd | registered as in Reg'd Pro, Registered Provider |
| rel | release |
| RQT | request |
| rev | review |
| Rpt | Report |
| rt | real time, may include day and time stamp data |
| RX | medical drugs or medical equipment |
| sec | security |
| sel | select |
| SL | security level (sometimes S1 for security level 1, etc.) |
| SR | sales representative |
| stmt | statement, as in bank statement, or payment made statement |
| Svr | sever, as in web server |
| sys | system |
| Sys Op | System Operator |
| t | time |
| telecom | telecommunications system or network |
| URL | Uniform Resource Locator, x pointer, or other network |
| | locator |
| univ. | universal application or common application |
| UPP | user personal profile, maybe UPP of Vendor's Owner and a |
| | different UPP for the Business Vendor |
| w/ | with |
| w/in | within |
| w/out | without |
| wrt | with respect to |

The telecommunications system or Internet enables communication and data transport between a plurality of relatively independent computer systems. The User-Vendor Computer system includes monitor, input device or keypad, input device or mouse, processor unit and a communications module which enables connection to the Internet or telecom network. Processor unit includes a central processing unit or CPU, memory and an input/output or I/O device. It should be appreciated that memory represents many types of data storage including hard drives, volatile and non-volatile memory, and removable drives. Also, I/O represents a plurality of input/output devices which are utilized to couple items which are peripheral to processing unit. I/O is connected to Internet. User-Vendor Computer may be a laptop computer or Internet-enabled tablet which can easily be connected from Internet. IPP Computer module is typically a server computer which communicates with the User-Vendor computer. Otherwise, the IPP computer or module communicates via secure data transfer with either the credit card processor, or in some instances, the credit card processor bank, or in other instances with the card issuer bank.

In a preferred embodiment, the system and method are deployed on Internet via computer system server. Other secure communications channels may be used as is common for financial transactions. The terms Internet and telecomm network are meant to cover secure financial transaction networks. Server includes CPU, memory and I/O, and is coupled to Internet.

In a preferred embodiment, inquiries regarding charitable contributions related to the credit card purchase of goods or services are obtained by utilizing a web browser or other type of interface on a User-Vendor computer (a client computer) as deployed by the IPP server module. The information obtained by User-Vendor computer is generally stored in the IPP server. Thereafter, the information is processed by IPP server and the output information representing processed data is delivered to the user-Vendor via Internet.

### Discussion of Hardware and Software Implementation Options

The present invention could be produced in hardware or software, or in a combination of hardware and software, and these implementations would be known to one of ordinary skill in the art. The system, or method, according to the inventive principles as disclosed in connection with the preferred embodiments, may be produced in a single computer system having separate elements or means for performing the individual functions or steps described or claimed or one or more elements or means combining the performance of any of the functions or steps disclosed or claimed, or may be arranged in a distributed computer system, interconnected by any suitable means as a local area network (LAN) or widely distributed network (WAN) over a telecommunications system (such as the Internet) as would be known to a person of ordinary skill in the art.

According to the inventive principles as disclosed in connection with the preferred embodiments, the invention and the inventive principles are not limited to any particular kind of computer system but may be used with any general purpose computer, as would be known to a person of ordinary skill in the art, arranged to perform the functions described and the method steps described herein. The operations of such a computer, as described above, may be according to a computer program contained on a medium for use in the operation or control of the computer, as would be known to person of ordinary skill in the art. The computer medium which may be used to hold or contain the computer program product, may be a fixture of the computer such as an embedded memory or may be on a transportable medium such as a disk, as would be known to one of ordinary skill in the art.

The invention is not limited to any particular computer program or logic or language, or instruction but may be practiced with any such suitable program, logic or language, or instructions as would be known to one of ordinary skill in the art. Without limiting the principles of the disclosed invention any such computing system can include, inter alia, at least a computer readable medium allowing a computer to read data, instructions, messages or message packets, and other computer readable information from the computer readable medium. The computer readable medium may include non-volatile memory, such as ROM, flash memory, floppy disk, disk drive memory, CD-ROM or other optical memory storage devices, and other permanent storage. Additionally, a computer readable medium may include, for example, volatile storage such as RAM, buffers, cache memory, and network circuits.

Furthermore, the computer readable medium may include computer readable information in a transitory state medium such as a network link and/or a network interface, including a wired network or a wireless network, that allow a computer to read such computer readable information.

The claims appended hereto are meant to cover modifications and changes within the scope and spirit of the present invention.

What is claimed is:

1. A computerized method for allocating charitable contributions based upon credit or debit card discount fees, which are selected by a vendor of goods or services from a plurality of card discount fees, the method enabled over a telecommunications network operable between said vendor's credit or debit card device, an associated card processor's computer system, a corresponding card issuer bank system, a vendor's bank system, an intermediary payment processor, an intermediary payment processor bank system, and a charity's bank system, said intermediary payment processor having a web-based server portal and a reporting module, the method comprising:
obtaining, via the server portal, a vendor selected discount fee from said plurality of discount fees, said selected discount fee corresponding to said associated card processor, said associated card processor having a relationship with said corresponding card issuer bank;
obtaining, via the server portal, one of (a) an estimate of vendor sales and calculating an estimated charitable contribution to a charity based thereon and effecting a display thereof or (b) effecting a display showing a discount rate percentage to be allocated to said charity as a result of vendor's sales;
establishing an electronic transactional relationship, via said telecommunications network, between said vendor's credit or debit card device, said associated card processor's computer system, said corresponding card issuer bank system, said vendor's bank system, said intermediary payment processor bank system, and said charity's bank system;
the electronic transactional relationship including processing credit or debit card transactions initiated at said vendor's credit or debit card device and engaging said associated card processor's computer system, said corresponding card issuer bank system, said vendor's bank system, and said intermediary payment processor bank system such that a portion of said discount fees from each credit or debit card transaction is delivered to the intermediary payment processor bank;
said intermediary payment processor bank system reporting payments based upon said portion of said discount fees to said intermediary payment processor;
establishing a further electronic transactional relationship between said intermediary payment processor bank system and said charity's bank system, including further processing said portion of said discount fees such that at least an allocation therefrom is delivered to said charity's bank from said intermediary payment processor bank;
said intermediary payment processor reporting said allocation via said reporting module to said vendor, wherein said allocation represents a charitable contribution associated with said vendor.

2. A method as claimed in claim 1 wherein said plurality of card discount fees are expressed as either transactional card discount fee rates or transactional card discount processing fees or as both fees and rates, and said server portal effects a display of at least one of said card discount rates or card processing fees.

3. A method as claimed in claim 1 wherein said intermediary payment processor, said server portal and said reporting module are incorporated into said associated card processor's computer system, and said intermediary payment processor bank system has an electronic transactional relationship with said associated card processor, said intermediary payment processor bank reporting transactions to said intermediary payment processor as part of said associated card processor's computer system.

4. A method as claimed in claim 1 wherein the delivery of said portion of said discount fees includes extracting fees from each credit or debit card transaction and delivering the same to said intermediary payment processor bank.

5. A method as claimed in claim 1 wherein said intermediary payment processor maintains a list of charities, each charity having at least a threshold contribution rate,
obtaining, via said server portal, a vendor selected charity after effecting a display of said list of charities;
wherein said selected charity's bank is delivered the charitable contribution by the intermediary payment processor bank.

6. A method as claimed in claim 1 wherein the server portal obtains said estimate of vendor's sales which sales are estimated over a predetermined period and the method includes calculating an estimated charitable contribution to a charity over a comparable or other predetermined period and effecting the display of the same via said server portal.

7. A method as claimed in claim 2 wherein said intermediary payment processor, said server portal and said reporting module are incorporated into said associated card processor's computer system, and said intermediary payment processor bank system has an electronic transactional relationship with said associated card processor, said intermediary payment processor bank reporting transactions to said intermediary payment processor as part of said associated card processor's computer system.

8. A method as claimed in claim 7 wherein said intermediary payment processor maintains a list of charities, each charity having at least a threshold contribution rate,
obtaining, via said server portal, a vendor selected charity after effecting a display of said list of charities;
wherein said selected charity's bank is delivered the charitable contribution by the intermediary payment processor bank.

9. A method as claimed in claim 8 wherein the server portal obtains said estimate of vendor's sales which sales are estimated over a predetermined period and the method includes calculating an estimated charitable contribution to a charity over a comparable or other predetermined period and effecting the display of the same via said server portal.

10. A computerized method for allocating charitable contributions based upon credit or debit card discount fees, which are selected by a vendor of goods or services from a plurality of credit card or debit card discount fees, the method enabled over a telecommunications network operable between said vendor's credit or debit card device, an associated card processor's computer system, a corresponding card issuer bank system, a vendor's bank system, an intermediary payment processor, an intermediary payment processor bank system, and a charity's bank system, said intermediary payment processor having a web-based server portal and a reporting module, the method comprising:
obtaining, via the server portal, a vendor selected discount fee from said plurality of discount fees, said selected discount fee corresponding to said associated card processor, said associated card processor having a relationship with said corresponding card issuer bank;
obtaining, via the server portal, one of an estimate of vendor sales and calculating an estimated charitable contribution to a charity based thereon and effecting a display thereof or effecting a display showing a discount rate percentage to be allocated to said charity as a result of vendor's sales;
obtaining confirmation, at said intermediary payment processor, of an established electronic transactional relationship, set up over said telecommunications network, between said vendor's credit or debit card device, said associated card processor's computer system, said corresponding card issuer bank system, said vendor's bank system, said intermediary payment processor bank system, and said charity's bank system;
obtaining a transactional confirmation, at said intermediary payment processor, of one or more electronic transactions which include data representing the processing credit or debit card transactions initiated at said vendor's credit or debit card device and processed though said associated card processor's computer system, said corresponding card issuer bank system, and said vendor's bank system;
as part of said one or more electronic transactions, effecting payment of a portion of said discount fees from each credit or debit card transaction to the intermediary payment processor bank, said payment made by either the associated card processor's bank or the corresponding card issuer bank;
obtaining confirmation, at said intermediary payment processor, of payments made to said intermediary payment processor bank based upon said portion of said discount fees;
obtaining a further transactional confirmation, at said intermediary payment processor, of an established further electronic transactional relationship between said intermediary payment processor bank system and said charity's bank system;
effecting the payment to said charity's bank from one of at least said intermediary payment processor bank, said associated card processor's bank or the corresponding card issuer bank of at least an allocation of said portion of said discount fees; and
said intermediary payment processor reporting said allocation payment via said reporting module to said vendor, wherein said allocation represents a charitable contribution associated with said vendor.

11. An electronic credit card and debit card processing system which allocates charitable contributions based upon credit or debit card discount fees to a selected charity's bank, the credit or debit transactions being subject to a vendor selected discount rate or fee from a plurality of card discount rates or fees, the electronic credit card and debit card processing system enabled over a telecommunications network operable between said vendor's credit or debit card device, an associated card processor's computer system, a corresponding card issuer bank system, a vendor's bank system, an intermediary payment processor, an intermediary payment processor bank system, and a charity's bank system, said intermediary payment processor having a web-based server portal, the processing system comprising:
means for selecting, at said server portal, a discount fee or rate from said plurality of discount fees or rates wherein the selected discount corresponds to said associated card processor who has a relationship with said corresponding card issuer bank;
means for inputting, at said server portal, an estimate of vendor sales;
a calculator in said intermediary payment processor for estimating a charitable contribution based upon the selected discount and said estimate of vendor sales;
means for effecting a display, via said server portal, of either (a) the estimating charitable contribution or (b) a discount rate percentage to be allocated to said charity as a result of vendor's sales, said discount rate percentage being less than the selected discount;
a transaction payment monitor in said intermediary payment processor and coupled to at least one of said associated card processor's computer system or the corresponding card issuer bank system, said transaction monitor further coupled to said intermediary payment processor bank system;
said transaction payment monitor tracking a portion of said discount fees from each credit or debit card transaction which portion is deposited into the intermediary payment processor bank based upon credit card or debit card discount fee payments originating from said vendor's credit or debit card device;
a payment module which effects payment of at least an allocated amount of funds from the discount fee portion, said payment module compiling allocations over a predetermined time period and thereafter instructing the payment of compiled allocated funds to said charity's bank from said intermediary payment processor bank;
said transaction payment monitor further tracking the electronic transfer of all compiled allocated funds from said intermediary payment processor bank to said charity's bank; and
said means for effecting the display also effecting the display of all transferred compiled allocated funds for said predetermined period of time; said display of transferred funds being made available to said vendor as a report on the charitable contributions to said charity.
